(19) United States
(12) Patent Application Publication
(10) Pub. No.: US 2024/0421548 A1
(43) Pub. Date: Dec. 19, 2024

(54) Electrical Transfer Tab for Motor Vehicles

(71) Applicant: Auto-Kabel Management GmbH, Hausen i.W. (DE)

(72) Inventor: Franz-Heinz Kaszubowski, Wassenberg (DE)

(21) Appl. No.: 18/698,566

(22) PCT Filed: Sep. 7, 2022
(86) PCT No.: PCT/EP2022/074865

§ 371 Date: Apr. 4, 2024

(30) Foreign Application Priority Data
Oct. 4, 2021 (DE) 10 2021 125 620.8

(51) Int. Cl. H01R 25/16; B60R 16/03; H01R 4/34; H01R 13/512; H01R 13/52

(52) U.S. Cl. CPC H01R 25/162; B60R 16/03; H01R 4/34; H01R 13/512; H01R 13/5202

(57) ABSTRACT

Electrical transfer tab for high power requirements, allowing a transition between at least two first connecting sections in a first arrangement and second connecting sections in a second arrangement different from the first.

The subject matter relates to an electrical transfer tab, in particular for motor vehicles.

In the course of the electrification of automobility, power of several hundred kW is nowadays occasionally transported via the vehicle network. With such enormous power peaks, a permanently safe conduction of the current and also of the heat resulting from ohmic losses is increasingly becoming a challenge. Against this background, the demands on the conductive components such as cables, connecting parts, connecting elements and also transfer tabs have increased enormously compared to previous 12V on-board networks.

One of the biggest challenges of the electrification of automobility lies in minimising the charging times of the energy storage systems involved. The tank of a conventional vehicle with a combustion engine is filled with fuel within a few minutes, which contains enough energy for hundreds of kilometres of driving distance. The situation is different, however, with electrically powered vehicles, where an electric accumulator with a high capacity usually has to be charged at a charging station. In order to charge the accumulator as quickly as possible, preferably much faster than it is subsequently discharged during driving, high currents and voltages are used.

In order to convey the necessary high charging power from the charging station to the vehicle accumulator, the entire transmission path from the charging station socket via the vehicle socket to the accumulator must have very good electrical conductivity. In particular, all transitions between the individual components of the transmission path must have particularly low contact resistances.

Conductive components must have high electrical and thermal conductivities, as well as high heat capacities. It must also be possible to release large amounts of heat into the environment. Local heating due to increased electrical and/or thermal resistance and/or low heat capacity can have fatal consequences for vehicle safety. The resulting high temperatures can cause fires and/or explosions.

A particularly sensitive area of the vehicle's electrical system is, by its very nature, the energy storage device involved and its direct electrical environment. The connections of an energy storage device, usually an electric accumulator, are often permanently connected to a transfer tab. The transfer tab may in particular provide the connection between the energy storage device and the rest of the vehicle network and/or a charging socket. All the power consumed in the vehicle flows through the connections of the energy storage device during battery operation. The same applies to the transfer tab.

It is often desirable, particularly for reasons of compact wiring, that the transfer tab allows a change in the orientation of the contacts in relation to the connections of the energy storage device. For example, the at least two terminals of the energy storage device may be spaced apart in a first direction. The terminals of the transfer tab may be spaced apart from each other in a different direction from the first direction. This results in difficulties for the electrical properties of the transfer tab, in particular because the current paths of the different connections have different geometric properties, in particular a different length. It would be desirable to match the current paths of the respective connections and to avoid imbalances in conductivity or other electrical and thermal properties. In particular, the high demands on the electrical and thermal properties of the transfer tab must be ensured to the required extent.

Finally, in view of the consistently high voltages between the connections of the energy storage device, it is important that it remains absolutely dry and/or is protected from other environmental influences such as oxidising gases. Preferably, the energy storage device is sealed from the environment of the vehicle and also from the interior of the vehicle. In particular, the transfer tab may connect the energy storage device to the interior of the vehicle. Accordingly, it must be designed in such a way that the sealing of the energy storage device against environmental influences remains unimpaired. The transfer tab can therefore also fulfil the function of a lead-through.

Thus, the subject matter was based on the object of providing a transfer tab that withstands the high electrical and thermal loads that act on the energy storage device of today's electric vehicles in direct connection with it.

The object is solved by a transfer tab according to claim 1.

The transfer tab according to the subject matter initially comprises at least two connecting flat parts.

A connecting flat part can have two broad sides, which are arranged opposite each other. The broad sides can, for example, be aligned essentially parallel to each other. The two broad sides can have essentially the same shape. Variations between the shapes of the broad sides are also possible. For example, one of the broad sides may have a smaller area than the other broad side of the connecting flat part.

For the connecting flat part, a thickness may be defined as the dimension of the connecting flat part perpendicular to at least one broad side of the connecting flat part. The thickness of the connection part may be substantially constant across at least one of the broad sides of the connection part. Also, the seal may vary across the broad side of the connecting flat part.

In addition, the connecting flat part comprises narrow sides. The narrow sides may surround the broad sides circumferentially. The narrow sides can be differentiated into individual narrow sides. A single, circumferential narrow side can also be defined. At least one of the narrow sides may be oriented substantially perpendicular to at least one broad side of the connecting flat part.

A substantially perpendicular orientation of two surfaces may be understood such that the two surface normals to the two surfaces are substantially perpendicular to each other.

Furthermore, it is useful to define a conductor plane in order to describe the geometric nature of the transfer tab. The conductor plane is not to be understood in the strict mathematical sense as a plane with a purely two-dimensional extension. The conductor plane can have an extension in all three spatial directions. In particular, the conductor plane can extend essentially indefinitely in two width directions perpendicular to each other. In a thickness direction of the conductor plane perpendicular to the width directions, the conductor plane can have a limited extension. This can be defined as the thickness of the conductor plane. The thickness direction may also be referred to hereinafter as the surface normal of the conductor plane.

At least one, preferably the at least two connecting flat parts extend in the conductor plane. The conductor plane may, for example, have essentially the same thickness as at least one of the connecting flat parts. The conductor plane may also be thicker or thinner than at least one of the connecting flat parts.

The at least two connecting flat parts may have substantially the same thickness. The at least two connecting flat parts may also have at least partially different, i.e. mutually different, thicknesses.

In one embodiment, the at least two connecting flat parts are aligned surface-parallel to each other. By this may be meant in particular that the broad sides of the at least two connecting parts are aligned substantially parallel to each other. At least one of the and/or the at least two connecting flat parts can be aligned parallel to the conductor plane. Also, at least one of the connecting flat parts may be angled with respect to the conductor plane. By this may be meant that at least one of the broad sides of the connecting flat part has a different orientation than the conductor plane. For example, there may be an angle of 5 to 10 degrees between the normal to the broad side of the connector flat and the normal to the conductor plane. Even if one of the connecting flat parts is defined as being parallel with the conductor plane, there may be a small angle, for example from 0.1 to 5 degrees, between the surface normal to the broad side of the connecting flat part and the surface normal to the conductor plane.

The at least two connecting flat parts do not touch each other. The at least two connecting flat parts are spaced apart from each other, in particular with a gap. In particular, the at least two connecting flat parts are electrically insulated from each other. The broad sides of the at least two connecting flat parts are arranged substantially free of overlap with respect to each other. In particular, in a top view of at least one broad side of at least one of the at least two connecting flat parts, it can be seen that the at least two connecting flat parts do not overlap each other. When it is mentioned in the following that the at least two connecting flat parts do not overlap each other and/or are free of overlaps, it is meant that the two connecting flat parts are free of overlaps in the direction of the surface normal to the conductor plane and/or in the direction of the surface normal to at least a part of a broad side of at least one of the at least two connecting flat parts. The at least two connecting flat parts may overlap each other in the direction of the surface normals on at least a part of the narrow sides. This is due to the fact that the at least two connecting flat parts lie in one plane, in particular in the conductor plane.

At least one, preferably the at least two connecting flat parts each comprise a first and a second connecting section. For example, the connecting sections may be arranged at a respective distal end of the respective connecting flat part. A connecting section may be suitable for connecting an electrically conductive member thereto. A connecting section has a spatial extent on the broad side of the connecting flat part. The connecting section may be adjacent to an edge of the broad side. Also, a connecting section may be circumferentially surrounded by regions of the broad side different therefrom.

For example, the connecting flat part may be divided into at least two connecting sections and a different conductor section. The conductor section may be electrically arranged between the two connecting sections. Also, the conductor section may comprise at least one of the connecting sections or the at least two connecting sections.

A first and a second connecting section can be defined for each connecting flat part. The first and the second connecting sections of a connecting flat part are in particular free of overlap.

The first connecting sections of the at least two connecting flat parts are arranged along a common first straight line. For example, the first connecting sections are spaced apart along the common first straight line. The common first straight line extends in the conductor plane. In particular, the common first straight line may be arranged parallel to at least one of the broad sides of at least one of the connecting flat parts. Additionally or alternatively, the first common straight line may be arranged parallel to the conductor plane. In particular, the first common straight line passes through both the first connecting section of a first one of the at least two connecting flat parts and the first connecting section of a second one of the at least two connecting flat parts. For example, the first straight line may pass through the centre of at least the first connecting section of a first and/or the at least two connecting flat parts. The centre may be defined here, for example, as the geometric centre of gravity of the surface of the first connecting section.

The second connecting sections of the at least two connecting flat parts are arranged along a common second straight line. For example, the second connecting sections are spaced apart along the common second straight line. The common second straight line extends in the conductor plane. In particular, the common second straight line may be arranged parallel to at least one of the broad sides of at least one of the connecting flat parts. Additionally or alternatively, the common second straight line may be arranged parallel to the conductor plane. In particular, the second common straight line extends through both the second connecting section of a first one of the at least two connecting flat parts and the second connecting section of a second one of the at least two connecting flat parts. For example, the second straight line may pass through the centre of at least the second connecting section of a first and/or the at least two connecting flat parts. The centre may be defined here, for example, as the geometric centre of gravity of the surface of the second connecting section.

The first connecting sections of the at least two connecting flat parts may be arranged on a common side of the second straight line. For example, the conductor plane can be divided by the second straight line into two regions separated from each other. In one of these two regions, the first section region, the at least two first connecting sections of the at least two connecting flat parts may be located. At least one of the connecting sections and/or the at least two connecting sections may be located entirely in the first section region. In this case, the second straight line does not pass through any of the first connecting sections. Also, at least one of the at least two connecting sections may be located only partially in the first connecting section region, in particular so that the second straight line passes through it. The at least two first connecting sections are each at least partially arranged in the first connecting section region. In particular, at least the respective centre of the at least two first connecting sections is arranged in the first section region. The centre can be defined here as described above, for example as the geometric centre of gravity of the respective first connecting section.

The second connecting sections are arranged on opposite sides of the first straight line, in particular in the conductor plane. The at least two second connecting sections can each be arranged completely on one of the two sides of the first straight line. In particular, the at least two second connecting sections can be free of a crossing by the first straight line. It is also possible that at least one or at least two of the second connecting sections are crossed by the first straight line. The at least two second connecting sections are each arranged at least partially on opposite regions of the first straight line. In particular, at least the respective centres of the at least two second connecting sections are arranged on opposite sides of the first straight line. The centre of a second connecting section can be defined here as described above, for example, as the geometric centre of gravity of the respective second connecting section.

In one embodiment, the at least two connecting flat parts extend in a longitudinal direction. In particular, a first connecting flat part may extend in a first longitudinal direction. In particular, a second connecting flat part may extend in a second longitudinal direction, wherein the first longitudinal direction may in particular substantially correspond to the second longitudinal direction. Also, the first and second longitudinal directions may differ from each other in their respective orientations.

For example, a longitudinal direction of a connecting flat part member may extend from the first connecting section of the connecting flat part member to the second connecting section of the connecting flat part member. Also, a longitudinal axis of a connecting flat part may be determined as the direction in which the connecting flat part has the greatest spatial extent. A common longitudinal direction may be defined for the at least two connecting flat parts. The common longitudinal direction of the at least two connecting flat parts may differ from the respective longitudinal directions of the connecting flat parts. Also, the longitudinal directions of the connecting flat parts may substantially coincide with the common longitudinal direction of the connecting flat parts.

In one embodiment, the at least two connecting flat parts may extend from a common first distal end to a common second distal end. In particular, the respective distal end may be a distal end of the transfer tab.

The first and/or the second distal end of the transfer tab may be a point on, for example, one of the at least two of the connecting flat parts. It is also possible to define the first and/or second distal end as a spatially extended region. In particular, the first and second distal ends of the transfer tab do not overlap.

For example, at least one first connecting section or the at least two first connecting sections of the transfer tab may be substantially arranged at the first distal end. They may also be only partially arranged at the first distal end. In the first distal end of the transfer tab, the end point of at least one of the at least two connecting flat parts may be located. For example, the end point of a connecting flat part may be defined as the point on the connecting flat part which marks the end of the connecting flat part along the longitudinal axis of the connecting flat part and/or along the common longitudinal direction of the transfer tab.

For example, at least one second connecting section and/or the at least two second connecting sections of the transfer tab may be substantially arranged at the second distal end. At least one of the at least two second connecting sections and/or the at least two second connecting sections may be arranged substantially entirely at the second distal end. It is also possible that at least one and/or the at least two second connecting sections are arranged partly outside the second distal end.

The above described arrangement of the first and the second connecting sections of the at least two connecting flat parts allows different orientations of the connecting sections. For example, the first connecting sections may be arranged in a first orientation and the second connecting sections may be arranged in a second orientation different therefrom, for example substantially perpendicular thereto. Changing the orientation of the connecting sections from first to second connecting sections enables compact contacting of an energy storage device. Typically, the terminals of an energy storage device are complained in a first orientation. The first orientation is often parallel to the edge of the energy storage device. Now, when two power lines that are aligned parallel to each other and run next to each other are contacted at the terminals of the energy storage device, they necessarily run perpendicular to the edge of the energy storage device in the first instance. In a car, it is often desired, especially for reasons of space saving, that one line runs parallel to the edge of the energy storage device. The change of direction made possible by the transfer tab is helpful here. However, it is challenging that two different paths result at the transfer tab for the at least two connections. These include, on the one hand, a path for the connection between the first and second connecting sections of a first connecting flat part and, on the other hand, a path between the first and second connecting sections of a second connecting flat part. In particular, a first one of the at least two first connecting sections of the at least two connecting flat parts is further away from the second connecting sections of the at least two connecting flat parts than at least a second one of the at least two first connecting sections. In particular, these mutually different paths arise because the at least two connecting flat parts are arranged substantially without overlapboltg with respect to each other.

Desirably, the at least two current-carrying paths are aligned in their electrical properties. If the at least two current-carrying paths have similar electrical properties to each other, an at least approximate symmetry between the at least two current-carrying paths is created. In this way, it can be achieved that none of the at least two current-carrying paths is exposed to increased heating, in particular due to ohmic losses.

Apparently, however, the arrangement of the at least two connecting flat parts, which are arranged without overlapboltg in a common conductor plane and have connecting sections that are oriented rotated relative to one another, leads to one of the current-carrying paths being significantly longer than the other current-carrying path. It seems more obvious to arrange the at least two connecting flat parts one above the other so that they overlap with their respective broad sides.

It has been recognised that interlocking the at least two connecting flat parts can minimise the differences in the path lengths of the current-carrying paths.

In one embodiment, at least a first one of the at least two connecting flat parts has a recess. In particular, the recess is located in an area close to the first connecting section of the connecting flat part. A recess in a connecting flat part is here a recess of the narrow side. The recess extends in particular over the entire thickness of the connecting flat part. Thus, in a top view of the broad side of the connecting flat part, in particular in a top view in the direction of the surface normal to the broad side of the connecting flat part, the recess appears as a narrowing of the broad side cut into the broad side.

To simplify the following description, a short and a long connecting flat part are first defined. The first connecting section of the short connecting flat part is closer to the second connecting sections of the at least two connecting flat parts than the first connecting section of the long connecting flat part.

In particular, the long connecting flat part has a recess.

The recess of the long connecting flat part may be arranged in a narrow edge of the long connecting flat part facing the short connecting flat part. Such a narrow side facing another connecting flat part may be designated as an inner narrow side.

A region of the short connecting flat part engages in the recess of the long connecting flat part. This may mean, for example, that the short connecting flat part projects at least partially into the convex envelope of the broad side of the long connecting flat part, in particular in the region of the recess.

In particular, the first connecting section of the short connecting flat part may at least partially engage in the recess of the long connecting flat part.

The width of the long connecting flat part may be reduced in the region of the recess of the long connecting flat part. The width may here be measured, for example, substantially perpendicular to the longitudinal direction of the connecting flat part and/or the longitudinal direction of the transfer tab. In particular, it is possible that the width of the long connecting flat part is not reduced in the region of the recess compared to other regions of the long connecting flat part different therefrom. This can be achieved, for example, by the narrow edge of the long connecting flat part being led away from the recess on the side of the long connecting flat part opposite the recess. In an exemplary embodiment, the two narrow sides of the long connecting flat part, which run essentially along the longitudinal direction of the connecting flat part and lie opposite one another, can be guided essentially parallel to one another, with deviations from a parallel course being permitted in certain areas. In this way, it can be achieved that the width of the long connecting flat part is substantially constant along the longitudinal direction.

The long connecting flat part can, for example, initially run in a substantially straight line along the longitudinal direction of the transfer tab, starting from the second connecting section. In the region of the first connecting section of the short connecting flat part, the course of the long connecting flat part may change from a substantially straight course to an at least partially curved course, the curved region leading at least partially around the first connecting section of the short connecting flat part.

The short connecting flat part may, for example, have a shape similar to that of an L. For example, the short connecting flat part may have a substantially straight leading portion between the first and second connecting sections of the short connecting flat part. The conductor section of the short connecting flat part member may extend substantially straight from the second connecting section towards the first connecting section of the first connecting flat part member. At the end of the conductor section opposite to the second connecting section, the first connecting section of the short connecting flat part may be arranged. The first connecting section of the short connecting flat part may extend in particular in the direction of the long connecting flat part. Consequently, in the present transfer tab, the first connecting section of the short connecting flat part may be offset in the direction of the long connecting flat part, for example substantially parallel to the second straight line and or substantially perpendicular to the first straight line. In this way, it can be achieved, for example, that the first connecting section of the short connecting flat part, in particular its centre, is arranged in projection parallel to the conductor plane and perpendicular to the second straight line at least partially and/or preferably completely between the second connecting sections of the short and the long connecting flat part. In order for the position of the first connecting section of the short connecting flat part to be chosen as described (offset in the direction of the long connecting flat part), the recess in the long connecting flat part allows the first connecting section of the short connecting flat part to engage there with the long connecting flat part.

The first connecting section of the long connecting flat part, in particular its centre, can also, like the first section of the short connecting flat part, lie in projection parallel to the conductor plane perpendicular to the second straight line at least partially between the second connecting sections of the short and the long connecting flat part. For this purpose, the first connecting section of the long connecting flat part is guided in the side of the long connecting flat part facing away from the second connecting sections of the long and short connecting flat parts in the direction of the short connecting flat part.

In the region of the conductor section of the short connecting flat part, the long connecting flat part may comprise a conductor section extending substantially parallel thereto.

Two of the at least two connecting flat parts have inner narrow sides which face the respective other connecting flat parts. A gap is arranged between the inner narrow sides of the at least two connecting flat parts. The gap may have a minimum width along the inner narrow sides. For example, at least 1 mm to 1 cm or a higher minimum width may be provided between the at least two connecting flat parts.

Two of the at least two connecting flat parts may also have a substantially constant distance to each other along the inner narrow sides. Deviations from a constant distance in certain areas are permitted.

In one embodiment, the first straight line is oriented substantially perpendicular to the second straight line. For example, the first straight line and the second straight line can enclose an angle of 90°+/−1° to +/−10°.

In one embodiment, the first straight line and the second straight line cross in the conductor plane. A crossing of two straight lines can mean in particular that they meet at a common point of intersection. A crossing of two straight lines can also mean that two straight lines meet at a respective point of intersection. On the respective straight line they come as close as possible. For example, the shortest distance between the two straight lines can be determined and the midpoint of this distance can be defined as the point of intersection of the straight lines, in particular without the two straight lines meeting.

In particular, the two straight lines may meet at an intersection point located between the second connecting sections of the at least two connecting flat parts.

In one embodiment, the second connecting sections of the at least two connecting flat parts may be equidistant from the first straight line. This may mean that the respective distances between the second connecting sections and the first straight line are substantially equal. For example, the distance between a second connecting section and the first straight line may be measured starting from the point of the second connecting section which is closest to the first straight line. The distance between a second connecting section and the first straight line can also be measured, for example, starting from the midpoint of the second connecting section to the first straight line. The centre point is determined here, for example, as the geometric centre of gravity of the second connecting section.

In one embodiment, the distance between the second connecting sections on two of the at least two connecting flat parts is substantially the same as the distance between the first connecting sections of the connecting flat parts.

At least one of the connecting flat parts may be formed from a metal material. In particular, a connecting flat part may be formed from aluminium, copper, E-copper and/or combinations thereof. Alloys of said materials and/or other metal materials are also possible.

For example, the at least two connecting flat parts may be formed of E-copper.

In one embodiment, at least one of the connecting flat parts is coated. In particular, at least one of the connecting flat parts may be coated with a metal material. For example, the connecting flat part may be coated with silver, gold, nickel, combinations thereof and/or with several layers in particular of said materials, in particular with under-nickel-plated silver.

At least one or the at least two connecting flat parts may be forged. Also, at least one of the connecting flat parts may be stamped, cut out, cast and/or injection moulded. A forged connecting flat part has the particular advantage that its shape can be freely designed and that the material has a high strength. In addition, particularly thick and thus well conducting—both thermally and electrically—connecting flat parts can be produced, as well as connecting flat parts with a high heat capacity.

In one embodiment, a connecting bolt may be arranged on at least one of the at least two connecting parts. The connecting bolt extends in particular in an extension direction beyond at least one broad side of the connecting flat part. The direction of extension of the connecting bolt can in particular run essentially perpendicular to the broad side of the connecting flat part.

The connecting bolt may in particular comprise a hole. The hole of the connecting bolt may, for example, be designed as a blind hole or a through hole. For example, a thread may be arranged in the hole. In particular, a blind hole in the connecting bolt may have a thread. The hole in the connecting bolt can, for example, run perpendicular to the direction in which the connecting bolt extends, at least partially through the connecting bolt. It is also possible for the hole to run essentially parallel to the direction in which the connecting bolt extends.

A connecting bolt may in particular be arranged in a connecting section of at least one of the and/or the at least two connecting flat parts. Preferably, the connecting bolt is arranged in the first connecting section of the connecting flat part.

In one embodiment, the present transfer tab is connected to an energy storage device by means of the second connecting section. Accordingly, the first connecting sections and in particular the connecting bolts arranged therein serve for contacting further lines which are connected to the vehicle network, for example. For example, cables can be screwed into the threads of the connecting bolts by means of screws. Cables can also be welded and/or clamped to the connecting bolts and/or plugged, riveted or otherwise connected.

In one embodiment, an opening is arranged in at least one of the at least two connecting flat parts. The opening extends in particular over the entire thickness of the connecting flat part. For example, the opening may be formed as a through hole. It is also possible that a blind hole is arranged in the connecting flat part. The opening of the connecting flat part may, for example, comprise a thread.

In one embodiment, an opening is arranged in at least one of and/or in the at least two connecting flat parts in the second connecting section.

It is also possible that openings are arranged in both the second and the first connecting sections of the at least two connecting flat parts, respectively. In an alternative embodiment, connecting bolts may also be arranged in each of the second and first connecting sections of the at least two connecting flat parts. In a preferred embodiment, at least one opening is arranged in each of the first connecting sections of the at least two connecting flat parts, and at least one connecting bolt is arranged in each of the first connecting sections.

In one embodiment, the at least two connecting flat parts are at least partially surrounded by a common housing.

The housing is preferably formed from a non-conductive material, for example a plastic, in particular a high-temperature plastic, for example PA6GF15, UL94 or another high-temperature plastic, and/or from another non-conductive material such as, for example, ceramic, glass, silicone, insulatingly coated metal and/or other materials.

In an embodiment, the at least two connecting flat parts are at least partially overmoulded by a common housing. In this way, a particularly good connection can be achieved between the housing and the surface of the connecting flat parts. In particular, it can be avoided in this way that liquid or other unwanted substances can be distributed along the connecting flat parts starting from the first connecting sections to the second connecting sections and/or vice versa.

Preferably, the housing is in direct contact, at least in some areas, with the connecting flat parts. In particular, the housing encloses the at least two connecting flat parts in the region of the conductor sections. In particular, the housing is at least partially arranged between the at least two connecting flat parts. In particular, the housing may be arranged at least partially between the inner narrow sides of the at least two connecting flat parts.

The housing fulfils, among other things, the function of insulating the connecting flat parts from each other. Another function of the housing is to protect the first connecting sections and the second connecting sections of the at least two connecting flat parts from each other. In particular, the housing can be used to prevent moisture located in the area of the first connecting sections from moving to the second connecting sections and vice versa. In particular, a housing tightly enclosing the at least two connecting flat parts can prevent longitudinal water along the connecting flat parts.

In particular, the housing may expose the first connecting sections and/or the second connecting sections. By this may be meant that no housing layer is arranged in the region of the first connecting sections and/or in the region of the second connecting sections of the at least two connecting flat parts. In this way, it can be ensured that the transfer tab according to the subject matter can be electrically contacted on both sides, namely in the area of the first connecting sections and in the area of the second connecting sections. In particular, the housing can completely surround all areas of the at least two connecting flat parts except for the first and second connecting sections.

A collar may be arranged in the region of the first and/or the second connecting sections of at least one of the at least two and/or the at least two connecting flat parts. The collar may surround, in particular encircle, at least one connecting section and or more connecting sections. A collar around a first connecting section of at least one of the at least two connecting flat parts may, for example, extend substantially perpendicular to the broad side of the connecting flat part. A collar around a second connecting section can, for example, likewise extend at least partially and/or completely circumferentially around at least one of and/or a plurality of second connecting sections of the at least two connecting flat parts substantially perpendicularly to the broad side of at least one of the connecting flat parts.

In the region of the first connecting sections, the housing may comprise a collar. The collar may extend in particular in the direction of the extension of at least one of the connecting bolts. The collar may surround the connecting bolts substantially circumferentially. The collar may project beyond the connecting bolts of the at least two connecting flat parts in the directions in which the connecting bolts extend. The connecting bolts are thus recessed in the area encompassed by the collar. In this way, safe contacting of the connecting bolts is simplified. In particular, accidental contacting is prevented. On the other hand, the area in which the connecting bolts are located can be better protected against environmental influences.

In an embodiment, at least one seal can be arranged on the housing.

For example, a seal may be formed from a flexible material, in particular from a plastic, silicone, rubber, cork or similar materials. In an embodiment, the seal can be manufactured together with the housing in a two-component injection moulding process. In this process, two different plastics of different softness are injected in a common process to form a housing. This results in a firm bond between the seal and the housing.

At least one of the at least one seal can in particular have a closed shape. For example, the seal may be in the form of a rectangle, for example with rounded corners, in the form of a circle, an ellipse, a polygon, or various other closed shapes.

At least one of the at least one seal may comprise multiple ribs. A multi-rib seal may increase sealing performance.

In particular, at least one of the at least one seal may be arranged around the first connecting sections of the at least two connecting flat parts, in particular around the connecting bolts. Alternatively or additionally, a seal may be arranged around the second connecting sections of the at least two connecting flat parts. By having at least one of the at least one seal arranged around the at least two second and/or the at least two first connecting sections, the subject transfer tab can be tightly connected to the first and/or second connecting sections with a further element. In particular, a gas-, liquid-, and/or pressure-tight sealing of such a transition to a further component can be enabled.

In one embodiment, the transfer tab comprises a housing closure. The housing closure may, for example, be formed as a cover. The housing closure may, for example, be adapted to the shape of the housing. The housing closure may be placed on the housing.

For example, the housing closure may contact the housing in a contact area. For example, the contact area between the housing closure and the housing may be arranged circumferentially around the first connecting sections. In one embodiment, at least one seal is located between the housing closure and the housing. This can be, for example, one of the at least one seals of the housing.

It is also possible that a seal is arranged on the housing closure. Also, the seal on the housing closure may be arranged circumferentially around the first connecting sections when the housing closure is in contact with the housing. The seal of the housing closure may abut the housing closure as a separate component. For example, a groove may be provided on the housing closure into which a seal may be inserted. For example, the seal of the housing closure may be formed from one of the materials of the seal of the housing listed above. Like the seal of the housing, the seal of the housing closure may also be manufactured in a two-component injection moulding process together with the housing closure.

The housing closure may be retained on the housing to prevent loss. For example, hinges, straps, splints or similar retaining means may be provided in which the housing closure is held to the housing in a manner that prevents loss.

At least one fastening means may be arranged on the housing. The fastening means may in particular be non-positive and/or positive fit. For example, the fastening means may comprise a screw receptacle and/or a thread for a screw. Also, a fastening means can be a hole in the housing. Fastening means may also be, for example, hooks, snaps, splints, clips, receptacles for one of these fastening means and/or other fastening means.

In particular, at least one thread may be embedded in the housing. The thread may for example be formed from a metal material, for example as screw receptacles. For example, the thread may be embedded in the housing wall, for example overmoulded. In particular, several threads can be arranged as fastening means on the housing, for example two, three, four or more threads.

The fastening means, in particular threads, may be arranged in the region surrounded by at least one of the at least one seals of the housing.

Alternatively or additionally, at least one fastening means may be provided on the housing closure. In particular, a hole may be provided on the housing closure, in particular a bushing, in particular a bushing for a screw, in particular made of a metal material. A lead-through can in particular be embedded in the housing wall, for example be injection-moulded and/or cast therein.

By means of at least one of the fastening means (of the housing and/or of the housing closure), the housing closure can be held on the housing. In particular, the housing closure may cover the region of the housing encompassed by one of the at least one seal. In particular, the at least one fastener may provide a contact pressure between the housing closure and the housing. In particular, an interference fit seal may be disposed between the housing and the housing closure. The at least one fastener may provide the interference fit. In particular, at least one screw can be passed through a hole in the housing cover, screwed into a screw receptacle, in particular a thread on the side of the housing, and thus effect a contact pressure.

In one embodiment, a sealing ring is arranged on at least one of the screws acting as fastening means. The sealing ring can, for example, engage around the screw shank, in particular circumferentially. The sealing ring may be arranged, for example, in the region of the screw head. The sealing ring can serve to provide a seal between the screw and the passage of the screw through the housing closure, in particular a gas-tight, liquid-tight and/or pressure-tight seal.

In one embodiment, the transfer tab may comprise at least one temperature sensor. For example, the temperature sensor may be arranged in the vicinity of at least one of the connecting flat parts. For example, the at least one temperature sensor may be arranged in proximity to at least one of the at least two first connecting sections. For example, the temperature sensor may be substantially the same distance from each of the at least two connecting sections. For example, the at least one temperature sensor may be arranged in an area encompassed by at least one of the at least one seals. In particular, the at least one temperature sensor may be arranged in a region coverable by the housing closure. For example, the temperature sensor may be at least partially moulded into the housing. For example, the housing has an opening exposing the receptive region of the temperature sensor.

In particular, the temperature sensor comprises at least one connection cable. The connection cable of the temperature sensor may be led out of the housing. In particular, the at least one connecting cable of the temperature sensor may be injection-moulded in the housing. The connection cable of the temperature sensor may be led out of the housing on a side of the housing facing away from the opening of the housing exposing the first connecting sections. In particular, the connection cable of the temperature sensor can be guided through the housing wall, in particular injected into the housing wall.

Since this is a component of the power electronics, monitoring the temperature is of utmost relevance for the safety of the vehicle. The fact that the temperature sensor is arranged in the direct vicinity of at least one of the connecting flat parts, preferably of the at least two connecting flat parts, means that the temperature of the connecting flat part can be detected particularly quickly and precisely.

In one embodiment, the transfer tab comprises at least one fuse. The fuse may in particular be arranged in the housing. In particular, the fuse may be arranged in a region of the housing surrounded by at least one of the at least one seals. For example, the at least one fuse may be arranged in the vicinity of at least one of the connecting flat parts. In particular, the fuse may be arranged in the vicinity of at least a first connecting section of the transfer tab.

In particular, the transfer tab may comprise a fuse which de-energises at least one of the connecting flat parts as long as the housing closure does not rest on the housing. In particular, this may be an HVIL fuse.

The at least one fuse may comprise at least one connecting cable. The at least one connecting cable of the at least one fuse may be led out of the housing. In particular, the at least one connecting cable of the fuse may be guided through a housing wall. For example, the at least one connecting cable of the fuse may be moulded and/or overmoulded in a housing wall of the housing. The at least one connecting cable of the at least one fuse may be guided out of the housing on a side of the housing facing away from the opening for the first connecting sections of the transfer tab.

In one embodiment, a wall is disposed between the housing and the housing closure. The wall may be formed of a conductive material, for example a metal material and/or other conductive materials. It is also possible to form the wall from an electrically non-conductive material, for example plastic, glass, ceramic and/or other non-conductive materials.

The wall may for example have an opening. In the opening, for example, the first connecting sections of the transfer tab may be arranged. For example, the opening may have a round, oval, rectangular, rounded rectangular, triangular, polygonal and/or otherwise shaped form. The opening may have an area that at least corresponds to the area occupied by a first and/or the at least two first connecting sections. In particular, the at least two connecting bolts may be accommodated in the opening of the wall. For example, at least one fuse can additionally be guided through the opening. In particular, the opening of the wall is smaller than the area enclosed by the seal of the housing and/or the seal of the housing closure. In particular, the respective seal may completely enclose the opening of the wall.

For example, the wall may have recesses. Fasteners, for example, can be passed through the recesses. In particular, screws can be guided through the recesses. The recesses can in particular be arranged in an area which can be completely enclosed by the seal of the housing and/or the seal of the housing closure, in particular together with the opening of the wall.

In particular, the at least one fastening means of the housing closure and/or of the housing may indirectly connect the housing closure to the housing via the wall. For example, at least one screw may be guided through a passage of the housing closure, through a recess of the wall into a screw receptacle of the housing.

In a preferred configuration, at least the housing closure is in direct contact with the wall in an at least partially circumferential region. For example, the housing closure can also be in indirect contact with the wall, in particular via a seal, in particular via a seal of the housing cover.

On the side of the housing, the wall may be in contact in a region extending at least partially circumferentially around the at least two first connecting sections. For example, the wall may abut at least one of the at least one seals of the housing, in particular circumferentially.

There may be an interference fit between the housing closure and the wall. In particular, a gasket, especially a gasket of the housing cover, may be press-fitted between the wall and the housing closure.

Alternatively or additionally, an interference fit may be present between the housing and the wall, in particular at least one of the at least one seals of the housing may be arranged between the wall and the housing in an interference fit.

In particular, at least one of the fastening means may hold the housing closure not only to the housing, but in particular to the wall and to the housing. For example, starting from the housing cover, at least one of the fastening means can be inserted through the wall, in particular through a recess of the wall, into a screw receptacle on the side of the housing, in particular into a thread. By means of the at least one fastening means, an interference fit can be produced between at least the housing cover and the wall, in particular by means of a seal. Also, by means of the at least one fastening means, a press fit between the housing and the wall can be achieved, in particular by means of a seal.

The transition between the housing closure and the wall and/or the transition between the housing and the wall may be at least substantially gas-tight, liquid-tight and/or pressure-tight.

For example, the wall may form at least part of a containment area surrounding an energy storage device. In another embodiment, the wall may define the interior of the vehicle.

In the following, the subject matter of the invention will be explained in more detail with reference to a drawing showing examples of embodiments. The drawing shows

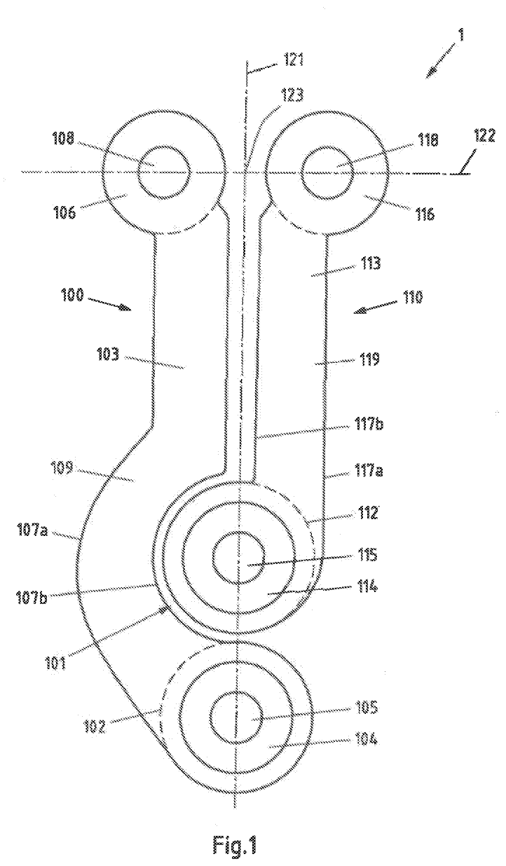

FIG. 1 a transfer tab according to an embodiment;

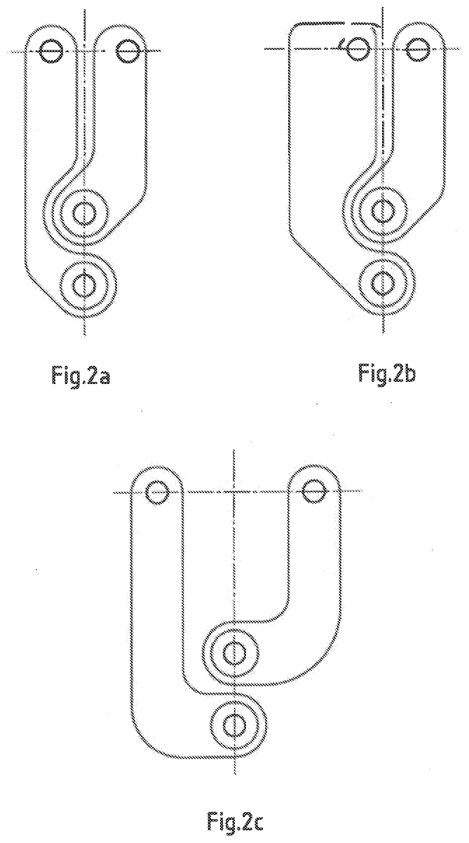

FIG. 2a-c transfer tabs according to embodiments;

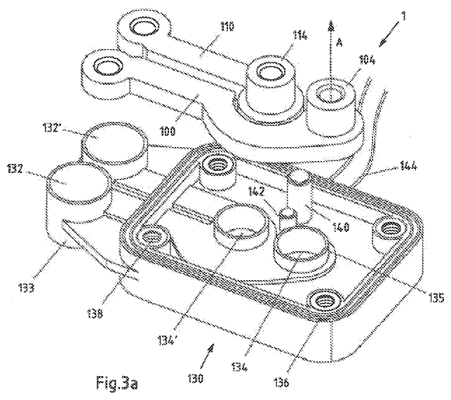

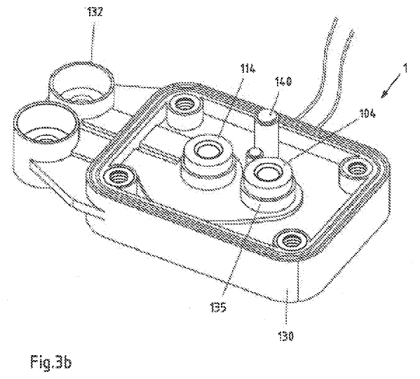

FIG. 3a, b a transfer tab according to an embodiment comprising a housing;

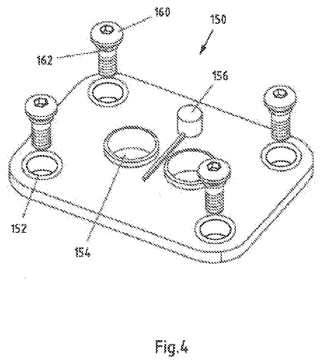

FIG. 4 a housing closure according to an embodiment;

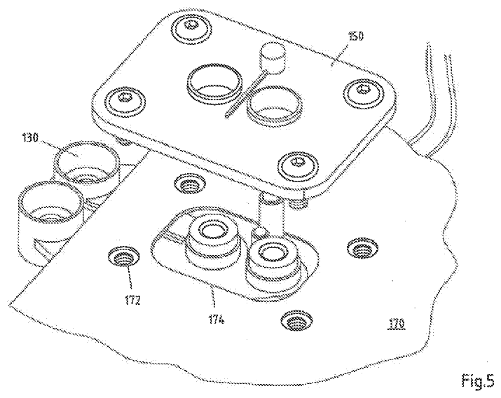

FIG. 5 a transfer tab according to an embodiment comprising a wall;

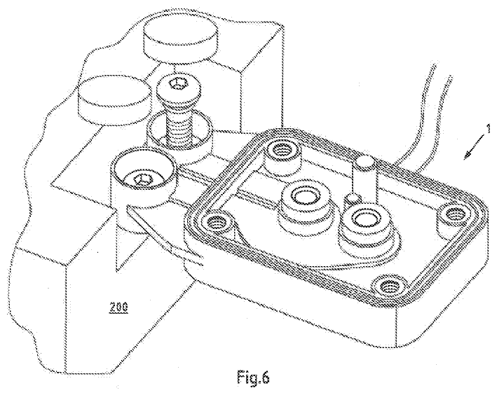

FIG. 6 a transfer tab according to an embodiment on an energy storage device.

FIG. 1 shows a transfer tab 1 according to the subject matter comprising a first connecting flat part 100 and a second connecting flat part 110. The first connecting flat part 100 and the second connecting flat part 110 each comprise a first connecting section 102, 112. The first connecting flat part 100 and the second connecting flat part 110 each further comprise a second connecting section 106, 116.

A connecting bolt 104, 114 may be disposed in the first connecting section 102, 112 of at least one of the connecting flat parts 100,110. The connecting bolt 104,114 may comprise a hole 105,115. The hole 105,115 may in particular be a blind hole. A thread may be arranged in at least one of the holes 105,115.

An opening 108,118 may be provided in the second connecting section 106,116 of at least one of the connecting flat parts 100,110. At least one of the openings 108,118 may in particular be a through hole 108,118.

In addition to the first connecting sections 102,112 and the second connecting sections 106,116, a conductor section 109,119 may be defined. The conductor section 109,119 may, for example, connect the first sections 102,112 to the second sections 106,116.

A broad side 103,113 can be defined for each of the connecting flat parts 100,110. Opposite the visible broad side 103,113 in FIG. 1 is another broad side which may be substantially parallel to and opposite the visible upper broad side 103,113. The surface orientation of the broad side 103,113 and or the surface orientation of the opposite broad side may be substantially constant for a respective connecting flat part 100,110. Also, the surface orientations of all four broad sides 103,113,etc. of the two connecting flat parts 100,110 shown may be substantially the same.

The at least two connecting flat parts 100,110 may be located in a common conductor plane.

In particular, the broad sides 103,113 of the at least two connecting flat parts 100,110 do not overlap each other, they are free of overlap. By this may be meant that in the top view of the at least two connecting flat parts 100, 110 in the direction of the surface normal to at least one broad side 103, 113 of the at least two flat parts 100, 110 as shown in FIG. 1, these are free of overlap, i.e. are spaced apart from each other.

In the embodiment shown, it can be seen that there is a gap between the two connecting flat parts 100,110. In particular, the gap and/or the distance between the at least two connecting flat parts 100,110 is substantially constant along the at least two connecting flat parts 100,110.

Also, narrow sides 107,117 can be defined for the two connecting flat parts 100,110. For example, the narrow sides can be arranged substantially perpendicular to the at least two broad sides 103,113. More precisely, outer narrow sides 107a, 117a can be defined. In addition, inner narrow sides 107b, 117b can be defined which face the respective other connecting flat part 100,110.

The connecting flat parts 100,110 can be divided into a long connecting flat part 100 and a short connecting flat part 110. The first connecting section 112 of the short connecting flat part 110 has a smaller distance to the second connecting sections 106,116 than the connecting section 102 of the long connecting flat part 100.

One of the connecting flat parts 100,110, in particular the long connecting flat part 100, has a recess 101. The recess 101 of the long connecting flat part 100 is arranged in particular in the conductor section 109. It can be seen that the width of the connecting flat part 100 remains substantially unchanged by the recess 101. This is achieved by guiding both the inner narrow side 107b and the outer narrow side 107a away from the short connecting flat part 110 in the region of the recess 101.

A first straight line 121 can be laid through the first connecting sections 102,112. In particular, the first straight line 121 runs substantially through the centre of at least one of the first connecting sections 102, 112. The centres can be defined here, for example, as the geometric centre of gravity of the respective first connecting section 102, 112. For example, the first straight line 121 can also run through the centre of at least one of the connecting bolts 104,114. In particular, the first straight line can run through one of the holes 105,115 of one of the connecting bolts 104,114, in particular through its centre.

A second straight line 122 can be laid through the second connecting sections 106,116. For example, the second straight line 122 runs substantially through the centres of the connecting sections 106, 116. For example, the straight line can also run through at least one of the openings 108, 118 of the first connecting sections 106, 116, in particular through their centres.

The second connecting sections 106, 116 are each located on opposite sides of the first straight line 121. In the embodiment shown, there is no overlap between the first straight line 101 and either of the second connecting sections 106, 116.

The first connecting sections 101,112 are arranged on a common side of the second straight line 122. In particular, in the embodiment shown, there is no overlap between the second straight line 122 and either of the first connecting sections 102,112.

The first straight line 121 and the second straight line 122 may intersect at an intersection point 123, in particular in the common conductor plane of the at least two connecting flat parts 100,110. The intersection point 123 may in particular be arranged in the conductor plane between the second connecting section 106 of the first connecting flat part 100 and the second connecting section 116 of the second connecting flat part 110. For example, as shown, the intersection point 123 of the first straight line 121 and the second straight line 122 may be located substantially centrally between the second connecting section 106 and the second connecting section 116.

FIG. 2 shows three alternative embodiments of a present transfer tab 1. In FIG. 2a it can be seen that the long connecting flat part 100 is narrowed in the region of the recess 101. Compared to the embodiment in FIG. 1, this has the disadvantage of a reduced conductor cross-section of the first connecting flat part 100 in the area of the recess 101.

FIG. 2b shows a further embodiment. In this embodiment, the conductor cross-section of the long flat part 100 is widened in the region of the second connecting section 106. Compared to the preferred embodiment in FIG. 1, the embodiment in FIG. 2b involves an increased material input.

Finally, FIG. 2c shows an embodiment in which the two connecting flat parts 100, 110 in the conductor section and in the region of the second connecting sections 106, 116 are not in direct spatial proximity to one another. Compared to the embodiment shown in FIG. 1, this embodiment has the disadvantage of an increased space requirement and a lower heat transfer between the two connecting flat parts 100, 110.

FIG. 3 shows a transfer tab 1 comprising a housing 130.

In the three-dimensional view of the connecting flat parts 100, 110 it can be seen that the connecting bolts 104, 114 extend in an extension direction A from the broad side 103, 113 of the respective connecting flat part 100, 110.

In particular, the housing 130 may be made from a non-conductive material, for example plastic, silicone, ceramic and/or other non-conductive materials. The housing 103 may be integrally made. In particular, the housing 130 may be moulded and/or injection moulded.

First openings 134, 134′ for the first connecting sections 102, 112 of the at least two connecting flat parts 100, 110 can be seen. The first openings 134, 134′ are in particular open towards the upper side of the housing 130 shown in FIG. 3a. In particular, the openings 134,134′ may be closed towards the lower side of the housing 130 opposite the upper side of the housing 130. A collar 135 may be arranged around the second openings 134,134′. In particular, the collar 135 may circumferentially surround at least one or the at least two second openings 134,134′. In particular, the collar 135 may extend substantially along the direction of extension A of at least one of the connecting bolts 104,114.

Second openings 132,132 are also provided in the housing. In particular, second openings 132,132′ are provided on the housing 130 for the second connecting sections 106,116. The second openings 132,132′ can in particular be open both to the upper side of the housing 130 shown in FIG. 3a and to the lower side of the housing 130 opposite thereto. At least one of the second openings 132,132′ can be formed as a through hole. In this way, it is possible for at least one and/or the at least two side regions 106,116 of both broad sides of the respective connecting flat part 100,110 to be accessible through the housing 130. For example, an object, in particular a screw, can be passed through at least one of the openings 108,118 arranged in a second connecting section 106,116 of at least one of the connecting flat parts 100,110.

The second openings 132,132′ may be enclosed by a collar 133. The collar 133 may extend substantially parallel to the surface normal to the broad side 103,113 and/or parallel to the direction of extension of at least one of the openings 108,118 in the second connecting section 106,116 of at least one of the connecting flat parts 100,110.

The housing 130 may further comprise at least one seal 136. The seal 136 may in particular comprise at least one, two, three and/or more ribs. In particular, the seal 136 may be circumferentially arranged around the at least two first connecting sections 102,112. In one embodiment, the seal 136 may be manufactured with the housing 130 in a common process, for example in a two-component injection moulding process.

Fastening means 138 may be arranged in the housing 130. In the embodiment shown, these are screw receptacles 138. For example, threads 138 made of a metal material may be embedded in the housing as shown. In this way, for example, screws can be received in the screw receptacles 138. Because the screw receptacles 138 are made of a metal material, they can absorb high forces.

As can be seen from FIG. 3a, the fasteners 138 are enclosed by the seal 136.

The present transfer tab 1 may further comprise at least one temperature sensor 142. In particular, the at least one temperature sensor 142 may be disposed within the housing 130. In particular, the temperature sensor 142 may be partially enclosed by the housing 130. Additionally and or alternatively, the temperature sensor 142 may be at least partially exposed from an opening of the housing 130, as shown in FIG. 3a. In particular, the housing 130 may expose a receptive region of the temperature sensor 142. In particular, a collar may at least partially surround the temperature sensor.

In particular, the temperature sensor 142 may be disposed in close proximity to at least one of the at least two connecting flat parts 100,110. In particular, the temperature sensor may be arranged in direct spatial proximity to the at least two first connecting sections 102,112 of the at least two connecting flat parts 100,110. FIG. 3a shows how the temperature sensor 142 is arranged between the first connecting sections 102,112 of the at least two connecting flat parts 100,110. Due to the direct proximity of the temperature sensor 142 to both the first connecting flat part 100 and the second connecting flat part 110, the temperature of both current-carrying connecting flat parts 100,110 can be detected with only one sensor. The temperature sensor is electrically insulated from the at least two connecting flat parts 100,110.

The present transfer tab 1 may further comprise a fuse 140. The fuse 140 may perform the function of de-energising at least one and/or the at least two connecting flat parts 100,110 if the housing 130 is unlocked. For example, this may be an HVIL fuse 140.

The fuse 140 and/or the temperature sensor 142 may each have at least one connecting lead 144. These are led out of the housing 133. In particular, the leads of the fuse 140 and/or the temperature sensor 142 may be guided through the housing 130, in particular be injection-moulded and/or cast therein. In particular, the connecting leads 144 are led out of the housing 130 on a lower side of the housing 130 facing away from the upper side of the housing 130 shown in FIG. 3a.

FIG. 3b shows the elements of FIG. 3a, namely the at least two connecting flat parts 100, 110, as well as the housing 130. The connecting flat parts 100, 110 are arranged inside the housing 130. It can be seen that the second connecting sections 106,116 are recessed in the collar 132 of the housing 130. By this may be meant that the collar 132 projects beyond at least one of the broad sides 103,113 of at least one of the connecting flat parts 100,110 in the direction of the surface normal to the broad side 103,113. In particular, the collar 132 may project beyond at least one and/or the at least two connecting flat parts 100, 110 on both sides, i.e. both on the upper side of the housing 130 shown in FIG. 3b and on the lower side of the housing 130 facing away therefrom.

It can also be seen that the connecting bolts 104, 114 project beyond the collar 135 of the housing 130 in the direction A in which they extend.

The fuse 140 may protrude beyond at least one of the at least two connecting bolts 104,114 in the direction of extension A thereof.

The connecting flat parts 100,110 may be moulded and/or injection-moulded into the housing 130.

FIG. 4 shows a housing closure 150.

The housing closure 150 may be formed from a non-conductive material, for example plastic, silicone, glass, ceramic and/or other non-conductive materials.

The housing closure 150 may have fastening means 152. In the embodiment shown, the fastening means 152 are formed as feedthroughs 152 for screws 160. The feedthroughs 152 are in particular formed from a metal material. The feedthroughs 152 are in particular recessed in the housing cover 150.

The housing cover 150 is suitable for being placed on the housing 130 in the upper portion of the housing 130 shown in FIG. 3. In particular, the housing cover 150 may rest on the seal 136 of the housing 130.

A screw 106 may be passed through at least one of the feedthroughs 152. A sealing ring 162 may be arranged on at least one of the screws 160. This may be particularly advantageous as the fastening means 138 of the housing 130 are arranged within the seal 136. The sealing rings 162 prevent moisture and/or other environmental influences from entering the interior of the housing 130, which is enclosed by the seal 136, via the screw passages 152.

The housing cover 150 further comprises at least one opening 154 through which, in particular, at least one of the connecting bolts 104, 114 of the at least two connecting flat parts 100, 110 can be passed. At least one or, as shown, both openings 154 may have a collar which extends, for example, substantially perpendicularly to the surface of the housing cover 150 surrounding it and/or substantially parallel to the direction of extension A of at least one of the connecting bolts 104, 114.

It can also be seen in FIG. 4 that a receptacle 156 is provided in the housing cover 150 for the fuse 140. Fuse 140 can engage in receptacle 156 when housing cover 150 rests on housing 130. In particular, fuse 140 overhangs the at least one connecting bolt 104,114. For example, receptacle 156 may be cross-sectionally adapted to a portion of fuse 140. By the fuse 140 being inserted into the receptacle 156 when the housing closure 150 is placed on the housing 130, the fuse 140 is protected from environmental influences, in particular also from high temperatures inside the housing.

Through the fastening means 152 of the housing closure 150, screws 160, for example, can be inserted into the fastening means 138, in particular into screw receptacles 138 of the housing 130, as explained above. In particular, the fastening means 138,152,160 can establish a contact pressure between the housing 130 and the housing closure 150. In particular, the fastening means 136,152,160 can be used to create an interference fit between at least the housing closure 150 and the seal 136 of the housing 130. Consequently, the housing closure 150 can be an interference fit against the housing 130 indirectly via the seal 136. In this way, it can be ensured that the interior of the housing 130 is protected from environmental influences.

The housing closure 150 may comprise a seal. In particular, the seal may describe substantially the same path as the seal 136 of the housing 130. In particular, the seal of the housing closure 150 may circumferentially surround the openings 154 and/or the fastening means 152. The seal of the housing closure 150 may be designed as a separate component. It is also possible to manufacture the seal of the housing closure 150 together with the housing closure 150 in a two-component injection moulding process.

As shown in FIG. 5, a wall 170 may be disposed between the housing 130 and the housing closure 150.

For example, the wall 170 may be formed from a conductive material such as a metal material, for example aluminium, copper and/or other metal materials and/or alloys thereof. It is also possible to form the wall 170 from a non-conductive material, for example plastic, ceramic, glass and/or other non-conductive materials.

In particular, the wall 170 may comprise at least one recess 172. At least one of the recesses 172 may be positioned to align with a fastener 138 of the housing 130 and/or a fastener 152 of the housing closure 150. In particular, at least one of the recesses 172 may be suitable for passing a screw 160 therethrough. Also, multiple recesses 182 may be provided, for example, as shown in FIG. 5, four recesses 172.

The wall 170 may comprise an opening 174. The opening 174 may be positioned in the wall 170 such that the first connection regions 102,112 of the transfer tab 1 are accessible through it. Also, the opening 132 may allow the fuse 140 and/or the temperature sensor 142 to pass through it. In an embodiment, the opening 174 comprises the at least two connecting bolts 104,114 of the subject transfer tab 1. In particular, at least one and/or the at least two connecting bolts 104,114 may be guided through the wall 170 in the region of the opening 174.

The size of the opening 174 of the wall 170 is in particular smaller than the area of the housing 130 which is enclosed by the seal 136. In particular, the seal 136 of the housing 130 is substantially continuous along the seal 136 against the wall 170. A substantially gas-tight, liquid-tight and/or pressure-tight connection can thus be formed between the seal 136 of the housing 130 and the wall 170.

The housing cover 150 may at least partially contact the wall 170. In particular, the housing cover 150 may contact in a region circumferentially enclosing the recesses 172.

For example, the housing cover 150 may contact the wall 170 by means of a seal of the housing cover 150.

By means of the fastening means 138,152,160, in particular, an interference fit can be produced between, on the one hand, the housing cover 150 and the wall 170 and/or, on the other hand, between the housing 130 and the wall 170. In particular, a seal 136 can be arranged between the wall 170 and the housing 130, in particular in an interference fit. A seal may be arranged between the wall 170 and the housing closure 150, in particular in an interference fit.

The wall 170 may, for example, perform a securing function. For example, the wall 170 may form part of an area enclosing an energy storage device, for example in a vehicle. The wall 170 can thus provide a spatial separation between an energy storage device and a remaining energy supply structure.

FIG. 6 shows an application of the present transfer tab 1 to an energy storage device 200.

The direction-changing function of the transfer tab 1 can be seen. It can also be guessed how the energy storage device 200 can be enclosed by a wall 170 (not shown).

1. Electrical transfer tab for motor vehicles comprising:
at least two connecting flat parts formed from a metallic material,
wherein the connecting flat parts extend at least partially in a common conductor plane,
wherein the connecting flat parts each have a first and a second connecting section, such that the first connecting sections are arranged along a common first straight line extending in the conductor plane, and,
the second connecting sections are arranged along a common second straight line extending in the conductor plane,
wherein
the first connecting sections are arranged on a common side of the second straight line, and
the second connecting sections are arranged on opposite sides of the first straight line.

2. Electrical transfer tab for motor vehicles according to claim 1, wherein the at least two connecting sections extend in a longitudinal direction.

3. Electrical transfer tab for motor vehicles according to claim 1, wherein
the at least two connecting sections extend from a common first distal end to a common second distal end, wherein in particular the first connecting sections are arranged at the first distal end and/or the second connecting sections are arranged at the second distal end.

4. Electrical transfer tab for motor vehicles according to claim 1, wherein
at least a first one of the at least two connecting flat parts has a recess in which a second one of the connecting flat parts engages, in particular the first connecting section of the second connecting flat part, wherein in particular the first connecting section of the second connecting flat part is arranged closer to at least one of the second connecting sections of the connecting flat parts than the first connecting section of the first connecting flat part.

5. Electrical transfer tab for motor vehicles according to claim 1, wherein
the connecting flat parts are at least partly at a substantially constant distance from each other along mutually facing narrow sides of the connecting flat parts.

6. Electrical transfer tab for motor vehicles according to claim 1, wherein
the first straight line is oriented substantially perpendicular to the second straight line.

7. Electrical transfer tab for motor vehicles according to claim 1, wherein
the first straight line and the second straight line cross each other in the conductor plane, in particular between the second connecting sections.

8. Electrical transfer tab for motor vehicles according to claim 1, wherein
the second connecting sections are substantially equidistant from the first straight line.

9. Electrical transfer tab for motor vehicles according to claim 1, wherein
at least one of the connecting sections is formed of aluminium, copper, E-copper and/or combinations thereof.

10. Electrical transfer tab for motor vehicles according to claim 1, wherein
at least one of the connecting flat parts is coated, in particular metallically coated, in particular with silver, gold, nickel, combinations thereof and/or with several layers, in particular with sub-nickel-plated silver.

11. Electrical transfer tab for motor vehicles according to claim 1, wherein
at least one of the connecting flat parts is forged.

12. Electrical transfer tab for motor vehicles according to claim 1, wherein
the connecting flat parts have a through-opening in at least one of the connecting sections, and/or
a connecting bolt is arranged in each case at least on one, preferably in at least two, of the first connecting sections, in particular a connecting bolt with a hole, in particular a connecting bolt with a blind hole, in particular a connecting bolt with a blind hole with a thread, the connecting bolt preferably being arranged in the through-opening.

13. Electrical transfer tab for motor vehicles claim 1, further comprising
a common housing at least partially surrounding the at least two connecting flat parts, in particular wherein the at least two connecting flat parts are at least partially encapsulated by a common housing.

14. Electrical transfer tab for motor vehicles according to claim 13, wherein
at least one seal is arranged on the housing, in particular circumferentially around the first connecting sections and/or circumferentially around the second connecting sections.

15. Electrical transfer tab for motor vehicles according to claim 13, wherein
the housing has a housing closure, the housing closure being in contact with the housing, in particular indirectly via a seal, in particular circumferentially around the first connecting sections, and/or
in that the housing closure comprises a seal, in particular a seal arranged circumferentially around the first connecting sections, in particular in that both the housing closure and the housing have at least one seal.

16. Electrical transfer tab for motor vehicles according to claim 13, wherein
at least one fastening means is arranged on the housing, in particular a thread for a screw, in particular a thread made of a metal material.

17. Electrical transfer tab for motor vehicles according to claim 15, wherein
at least one fastening means is arranged on the housing closure, in particular a hole, in particular a through hole, in particular made of a metal material, wherein in particular a seal can be fastened between the housing closure and the housing by means of the at least one fastening means in an interference fit.

18. Electrical transfer tab for motor vehicles according to claim 17, wherein
the at least one fastening means comprises a screw with a sealing ring.

19. Electrical transfer tab for motor vehicles according to claim 13, further comprising
at least one temperature sensor and/or a fuse, in particular inside the housing.

20. Electrical transfer tab for motor vehicles according to claim 15, wherein
a wall is arranged between the housing and the housing closure, wherein in particular at least one of the holding means holds the housing closure to the housing indirectly via the wall and in particular the transition between the housing closure and the wall and/or the transition between the housing and the wall is at least substantially gas-tight, liquid-tight and/or pressure-tight.

21. Electrical transfer tab for motor vehicles according to claim 20, wherein
the wall has at least one recess through which, in particular, a fastening means can be passed, in particular a screw.

22. Electrical transfer tab for motor vehicles according to claim 20, wherein
the wall is formed from a metal material and/or from a plastic material.
